(19) United States
(12) Patent Application Publication
(10) Pub. No.: US 2007/0096649 A1
(43) Pub. Date: May 3, 2007

(54) Electrode-mounted getter

(76) Inventor: Timothy J. Roels, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,344

(22) Filed: Oct. 28, 2005

(51) Int. Cl. H01K 1/54

(52) U.S. Cl. 313/548

(57) ABSTRACT

A getter for a lamp includes a substrate, having a generally annular shape, and a heat-activated getter material disposed on the substrate. The getter material is configured to absorb undesired chemical impurities within the lamp. The substrate defines an inner aperture, configured to deformably press-fit onto an electrode of a lamp so as to conduct heat from the electrode to the getter material.

### BACKGROUND

A getter is a material that is formulated to absorb undesired chemical impurities in a sealed environment. Lamps, such as high pressure discharge lamps, typically use getters in order to enhance their performance and useful life. Getters in lamps are activated by high temperature and collect and capture undesirable contaminants while the lamp is operating. These contaminants can affect various performance characteristics of the lamp (e.g. ignition voltage, useful life) if they are not captured. In high pressure discharge lamps, for example, getters can be used to absorb hydrogen to limit deterioration of vacuum pressure or gas purity due to gas release from the hot lamp burner.

A getter is frequently a moldable material, which is often shaped into a pill or tablet. The tablet is then attached to a metal casing, which can be welded into place within the lamp. Getters also generally require high temperature for activation. Consequently, in a typical installation the getter is not located at the hottest spot within the lamp, with the result that its performance is not optimized. Being away from the hot spot, it may take longer for the getter to reach operating temperature, and the getter may never reach the proper temperature for optimum effectiveness.

To provide more thermal energy to the getter, some lamps have located the getter on one of the spider arms of a lamp cathode. While this helps heat the getter, it decentralizes the getter and can create blockage of light emission, particularly unbalanced blockage, hindering the operation and efficiency of the lamp.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a side, cross-sectional view of an electrode assembly of a high pressure projector lamp having an annularly shaped getter attached to the cathode;

FIG. 2 is a perspective view of an embodiment of an annularly shaped getter configured for attachment to a lamp electrode;

FIG. 3 is a plan view of another embodiment of an annularly shaped getter configured for attachment to a lamp electrode;

FIG. 4A is a side, cross-sectional view of one embodiment of an annularly shaped getter configured for mounting on a lamp electrode;

FIG. 4B is a side, cross-sectional view of one embodiment of an annularly shaped getter configured for mounting on a lamp electrode;

FIG. 5 is a detail cross-sectional view of the getter cup aperture rim of FIG. 4A;

FIG. 6A is a perspective view of another embodiment of an annularly shaped getter; and

FIG. 6B is a perspective view of yet another embodiment of an annularly shaped getter.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

As noted above, getters are often used in lamps, such as high pressure projector lamps, to absorb impurities in the sealed lamp environment. Some of these contaminants or impurities may be introduced during manufacture of the lamp. Others can be created during operation of the lamp, such as through outgassing from a hot lamp electrode. Impurities and contaminants in a high temperature lamp environment can cause plating, corrosion, and other deterioration of lamp components, which can affect the durability and performance characteristics of the lamp, such as its ignition voltage, brightness, and useful life. The getter is designed to collect and absorb these impurities to prevent this damage.

Unfortunately, the design and placement of the getter has a great influence on its effectiveness. Getters are heat activated. However, the minimum activation temperature of getter materials can vary. Some getters can be activated at temperatures as low as 300° C. if that temperature is maintained over a relatively long duration (e.g. 5 hours), while others require a much higher activation temperature (e.g. 750° C. to 900° C.). Both the cathode and anode of many projector lamps can reach temperatures above 1000° C. However, some areas of the lamp away from the electrodes may not reach these temperatures, or even reach the getter activation temperature, or may reach the getter activation temperature only slowly. If the getter does not reach an optimum operating temperature, the getter will not properly absorb impurities in the lamp environment, thus contributing to deterioration of the lamp components. Furthermore, if the getter does not reach its activation temperature quickly, damage can be done each time the lamp is turned on during the time interval after actuation of the lamp and before the getter reaches its activation temperature.

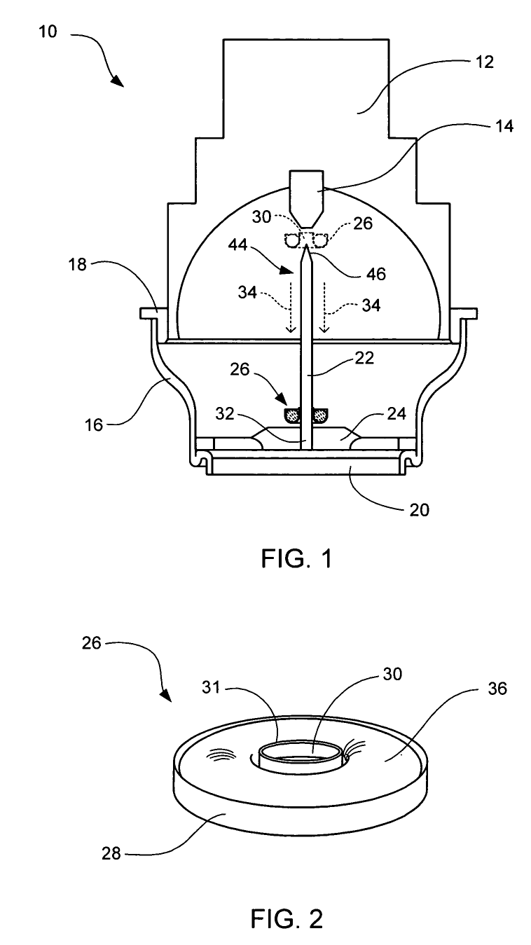

Shown in FIG. 1 is a cross-sectional view of one embodiment of a high pressure Xenon projector lamp assembly 10. This lamp generally includes a reflector housing 12, and an anode 14 mounted in the housing. A lamp nose cap 16 is attached to the housing with an insulator material 18 therebetween, and a lamp window 20 is provided in the nose cap. The cathode 22 is mounted to a cathode strut 24 within the nose cap, and the cathode post extends to a point just opposite the anode.

As shown in FIG. 1, an annularly shaped getter 26 is mounted on the cathode post 22 in the lamp 10. While the getter is shown mounted to the cathode, the designation of anode and cathode could be reversed, and the getter could also be attached to the anode. Consequently, the references herein to a lamp electrode are intended to encompass both cathodes and anodes.

An embodiment of a getter like that shown in FIG. 1 is shown in greater detail in FIG. 2. The getter includes a substrate 28 with a central aperture 30 that is configured to press-fit upon the cathode post. The substrate can have an open-faced trough or cup shape, as shown in FIG. 2, though other shapes are also possible, as discussed below. The terms “getter cup” and “getter trough” are also used herein to refer to the getter substrate. When pressed down toward the base 32 of the cathode post (in the direction of arrows 34 in FIG. 1), the getter is placed in a location that minimizes its potential obstruction of light produced by the lamp. However, since the getter is in direct mechanical contact with the cathode, and the cathode reaches a high temperature very quickly, the getter also heats up very quickly, reaching its activation temperature quickly and maintaining that temperature.

A closer view of one embodiment of an annularly shaped electrode mountable getter 26 is provided in FIG. 2. In this view the annular cup-like shape of the getter substrate is apparent. The getter cup can be of metal, such as nickel plated iron, steel, molybdenum, stainless steel, nickel steel (Kovar), tungsten, titanium, tantalum, or other thermally conductive materials capable of withstanding the high temperature lamp environment. A metal getter cup can be inexpensive and simple to manufacture, and also conducts heat very well.

The getter material is generally moldable and can be shaped into any desired shape. Getter materials are typically formed as a powder, and then pressed onto a metal substrate in some particular shape, such as a tablet. In the present application, the getter material can be pressed onto/into the getter cup in the desired shape. Other means of dispensing the getter may be possible depending upon the getter type and manufacturing process used. In the embodiment of FIG. 2, a cylindrical ring 36 of getter material, having a toroid or donut shape, is attached within the getter cup 28. Alternatively, as shown in FIG. 4B, the getter material can be shaped as a half toroid 38 to exactly or very nearly match the shape of the getter cup. Optimizing the exposed surface area of the getter material can be advantageous, depending upon the lamp hermeticity and design. Generally, the larger the surface area, the more rapidly the getter will absorb impurities. However, there is also a molecular migration within the getter material, so that the getter will continue to absorb impurities until the getter is fully saturated. Consequently, the amount or rate of absorption can remain relatively constant over the life of the getter.

Other configurations of the getter and its substrate are also possible, as illustrated in FIGS. 6A-6B. As shown in FIG. 6A, an alternative getter 60a can include a getter substrate that is a generally planar annular disc 62 having a central sleeve 64 that extends upwardly from the plane of the disc and is configured to slide over and press onto the lamp electrode. A substantially flat cylindrical disc 66a of getter material (essentially a tablet shape with a center portion punched out) is attached to the upper face of the getter substrate surrounding the sleeve. As shown in FIG. 6B, another alternative getter 60b can include a lower flat cylindrical disc of getter material 66b that is attached to the lower face of the getter substrate, in addition to the upper disc of getter material 66a, providing two layers of getter material attached to one getter substrate. It will be apparent that the diameter and thickness of the getter material and the getter substrate can vary.

The getter material can be any of a variety of materials that are used as getters. A particular material is selected for a particular application depending upon the undesirable impurities that are to be collected and captured while the lamp is operating. For example, one type of getter material may be suitable for absorbing hydrogen (H₂), while another material is suitable for absorbing carbon dioxide (CO₂). Getter materials that absorb multiple types of impurities are also available. Those skilled in the art will be able to select a proper getter material for a given application.

A wide variety of getters are commercially available. One commercial source of getters for a variety of applications is SAES Getters of Milan, Italy. For a sealed Xenon projector lamp such as that pictured in FIG. 1, the inventor has used an ST-101 getter from SAES Getters. The ST-101 getter is a zirconium-aluminum alloy that is configured to absorb hydrogen (H₂), oxygen (O₂), carbon monoxide (CO), carbon dioxide (CO₂), nitrogen (N₂), water (H₂O), and methane (CH₄).

As noted above, the activation temperature for getter materials varies. For the electrode-mounted getter disclosed herein, higher activation temperatures are desirable because brazing, bake-out, and other operations during the lamp manufacturing process produce elevated temperatures. If the activation temperature of the getter material is relatively low, these higher temperature manufacturing processes could prematurely activate the getter, causing the getter to become saturated with impurities before the lamp is sealed. To help prevent premature saturation, a getter material with a higher activation temperature is desirable to resist activation during the manufacturing process.

The ST-101 getter requires a temperature of about 900° C. for 30 seconds to activate, but will activate faster if the temperature is higher. The ST-101 getter will also activate when exposed to a temperature of 800° C. for 5 minutes, or 750° C. for 20-30 minutes. Other getter materials have different activation time and temperature characteristics. Those skilled in the art will be able to select a proper getter material for a given temperature range.

The cross-sectional shape of the annular getter substrate can vary. For example, the getter cup 28 depicted in FIG. 4A has a generally squared shape, with the upper rim 31 of the central aperture 30 extending slightly higher than the outer rim 40. Alternatively, as shown in FIG. 4B, the outer rim 42 and inner rim 43 can be configured to have roughly the same height, with the getter cup 28a having a more rounded shape. It will be apparent that other shapes are also possible.

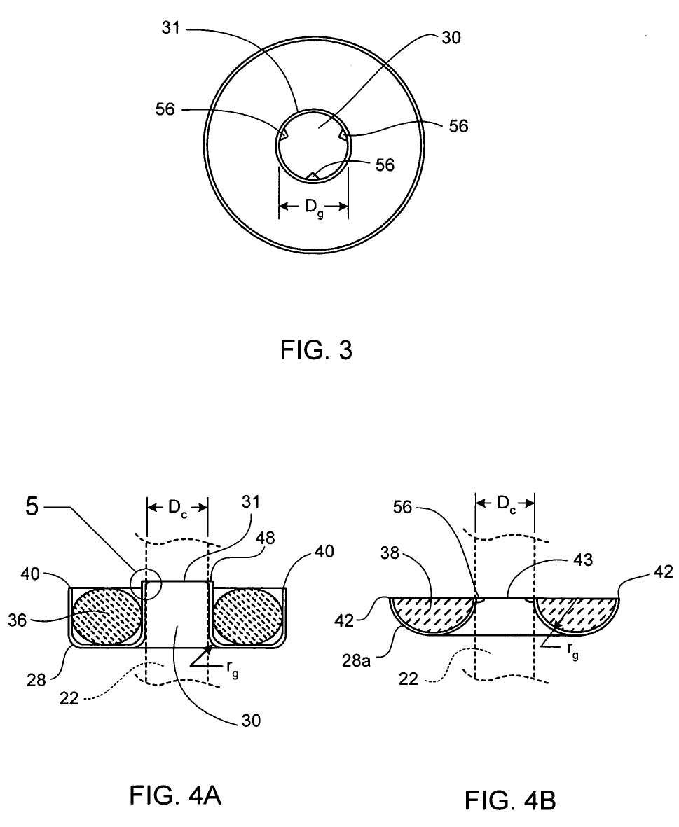

Referring to FIGS. 3 and 4, the central aperture 30 of the getter cup 28 has a diameter D_{g} that can be slightly smaller than the diameter D_{c} of the cathode. This allows the getter cup to be pressed onto the cathode 22 and obtain a snug fit. Where the getter cup is of metal, the malleability of the metal will allow the smaller getter aperture to deform slightly to conform to the size of the cathode and provide a secure fit. The sleeve 64 of the flat disc getter substrate 62 shown in FIGS. 6A and 6B can also include this smaller diameter aperture for providing a press fit.

Additionally, as shown in the cross-sectional views of FIGS. 4A and 4B, the bottom of the getter cup can have a radius r_{g} that helps promote sliding of the getter onto the cathode. This radius on the under inside of the cup can assist alignment and pressing of the getter assembly into location. This radius can vary, as shown, for example, in the different embodiments of FIGS. 4A and 4B.

The press-fit operation is illustrated in dashed lines in FIG. 1. Prior to placement, the getter 26 is aligned with the free end 44 of the cathode 22, and with the getter aperture 30 aligned with the cathode, the getter is pressed down onto the electrode in the direction of arrows 34. The radius r_{g} of the bottom side of the getter cup helps the getter slide down the cathode post. A point 46 on the free end of the cathode can also assist in this press-on operation.

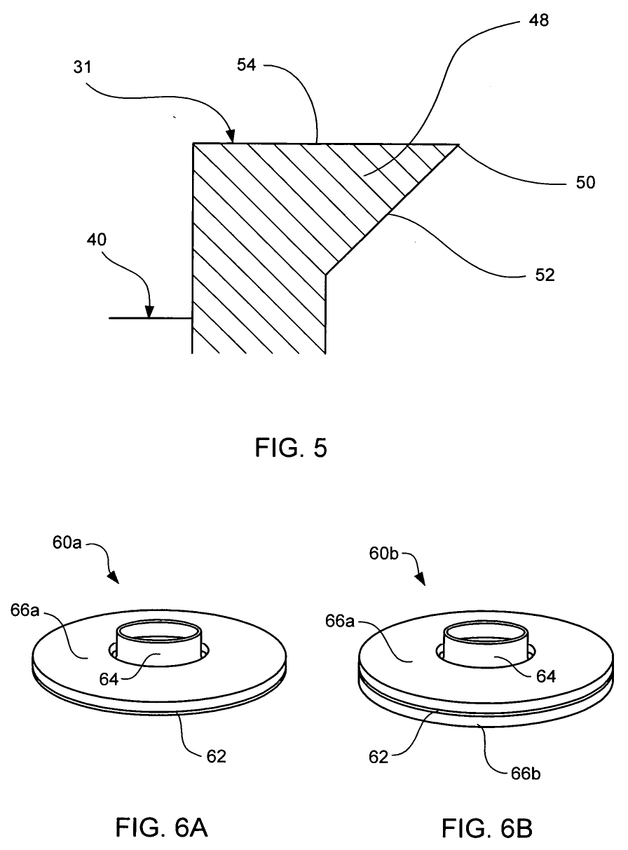

The getter cup 28 can also be provided with a number of features that provide affixing structure to enhance the press fit and resist retraction of the getter cup from the cathode 22. As shown in FIG. 4A, the upper rim 31 of the central aperture 30 of the getter cup can have a lip or ridge 48 on its inside edge. This lip or ridge 48 can be shaped to dig in the cathode post, so that the getter will slide on in one direction, but resist retraction in the other direction. As seen more clearly in FIG. 5, this lip or ridge can be configured to have a beveled or knife edge 50 that has a sloped lower side 52 that allows sliding down onto the cathode, while a perpendicular top side 54 causes the knife edge to tend to dig into the cathode to resist retraction. This lip or ridge can be substantially or completely continuous around the inner edge of the annular aperture in the getter cup, or it can be discontinuous or in one or more discrete portions.

An alternative configuration for the retraction-resistant lip or ridge is shown in FIG. 3. In this embodiment, several locking tabs or wedges 56 extend inwardly from the inner edge of the getter cup aperture 30. When the getter cup is pressed onto the cathode 22, these tabs deflect to allow sliding of the getter post in the aperture. However, once in place, the tabs will naturally spring back toward their undeflected orientation, and will tend to dig into the cathode post to resist retraction. This will help secure the getter on the post. While three tabs are shown in FIG. 3, the getter cup can be configured with just one or any number.

The locking tabs 56 shown in FIG. 3 can have a constant thickness. Alternatively, as shown in FIG. 4B, the locking tabs can have a wedge shaped configuration similar to that shown in FIG. 5 to help promote the pressing of the getter onto the cathode. Those skilled in the art will be able to determine the size, number, and configuration of the lip, ridges, tabs or other affixing structure for securing the getter cup to the cathode. It will be apparent that the various retraction resistant features shown and described with respect to the trough or cup shaped getter substrates of FIGS. 1-4 can also be provided in the flat disc substrate embodiment shown in FIGS. 6A and 6B.

This getter configuration provides a number of desirable features. Because the getter substrate is pressed onto the cathode post, the need for welding can be eliminated. Further, pressing the getter substrate on to the cathode post locates the getter close to the hot spot in the lamp. The avoidance of welding provides a simpler installation process, and eliminates a source of deposits and contaminants in the lamp, which can create undesirable lamp performance issues or necessitate a follow-up cleaning process. Additionally, by placing the getter substrate in intimate contact with the heated cathode electrode, the getter collects heat through the thermally conductive substrate and surroundings, so that a higher temperature can be reached and reached more quickly for activation of the getter material.

The getter is also shaped and sized to minimize shadows or blockage of light out of the reflector housing. Since the getter is located on the cathode shaft, which already creates some light blockage, and is positioned near the base of the cathode shaft, any additional blockage created by the getter is minimal, and the blockage is centralized for less unbalanced light obstruction and more uniform light out of the reflector housing.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A getter for a lamp, comprising:
a substrate, having a generally annular shape, and defining an inner aperture, the inner aperture being configured to deformably press-fit onto an electrode of a lamp and to be in intimate contact with the electrode; and
a heat-activated getter material, disposed on the substrate, configured to absorb undesired chemical impurities within the lamp.

2. A getter in accordance with claim 1, wherein the electrode comprises a cathode of the lamp.

3. A getter in accordance with claim 1, wherein the getter material is configured in a shape selected from the group consisting of a substantially continuous toroid, a substantially continuous half toroid, and a substantially flat cylindrical disc.

4. A getter in accordance with claim 1, wherein the getter material comprises a zirconium-aluminum alloy.

5. A getter in accordance with claim 1, wherein the getter material is configured to absorb at least one chemical species selected from the group consisting of hydrogen, oxygen, carbon monoxide, carbon dioxide, nitrogen, water, and methane.

6. A getter in accordance with claim 1, wherein the getter material is configured to activate at a temperature at or above about 750° C.

7. A getter in accordance with claim 1, further comprising a lip, extending into the inner aperture of the getter substrate, configured to allow pressing of the metal substrate onto the electrode, but to resist removal therefrom.

8. A getter in accordance with claim 7, wherein the lip includes a sloped side configured to slide over a surface of the electrode during movement of the substrate upon the electrode in a first installation direction, and an edge configured to dig into the surface of the electrode to resist movement of the substrate in a second removal direction.

9. A getter in accordance with claim 8, wherein the lip includes at least two discontinuous portions.

10. A getter in accordance with claim 7, wherein the lip includes at least one tab, configured to deflect to allow sliding of the substrate onto the electrode, and to spring back toward an undeflected orientation to resist removal of the substrate from the electrode.

11. A getter in accordance with claim 1, wherein the substrate is of a metal selected from the group consisting of nickel plated iron, steel, molybdenum, stainless steel, nickel steel, tungsten, titanium, and tantalum.

12. A lamp, comprising:
a sealed lamp enclosure;
an elongate electrode, having a base region, disposed within the sealed lamp enclosure; and
a substantially continuous ring of heat-activated getter material, attached to the electrode, the electrode extending through an annulus of the ring of getter material, the getter material configured to absorb undesired chemical impurities within the sealed lamp enclosure when heated by the electrode.

13. A lamp in accordance with claim 12, further comprising a metal substrate, supporting the ring of getter material, the metal substrate configured to press-fit onto the electrode.

14. A lamp in accordance with claim 12, wherein the getter is attached to the electrode near the base region.

15. A lamp in accordance with claim 12, wherein the electrode is a cathode of the lamp.

16. A lamp in accordance with claim 12, wherein the getter material is configured to absorb at least one chemical species selected from the group consisting of hydrogen, oxygen, carbon monoxide, carbon dioxide, nitrogen, water, and methane.

17. A getter for a lamp having an electrode, comprising:
a heat-activated getter material, configured to absorb undesired chemical impurities within the lamp; and
means for attaching the getter material via a press fit to the electrode, so as to conduct heat directly from the electrode to the getter material.

18. A getter in accordance with claim 17, wherein the means for attaching the getter material comprises a metal substrate, having a generally annular shape, and defining an inner aperture, the inner aperture being configured to press-fit onto the electrode.

19. A getter in accordance with claim 17, further comprising means for resisting removal of the metal substrate from the electrode.

20. A getter in accordance with claim 19, wherein the means for resisting removal comprises a lip, extending into the inner aperture of the metal substrate, configured to allow pressing of the metal substrate onto the electrode, but to dig into the electrode to resist removal therefrom.
